(19) United States
(12) Patent Application Publication
(10) Pub. No.: US 2026/0066331 A1
(43) Pub. Date: Mar. 5, 2026

(54) PRESS PLATE FOR FLATTENING POUCH-TYPE CELL AND METHOD OF MANUFACTURING POUCH-TYPE CELL USING THE SAME

(71) Applicant: Samsung SDI Co., Ltd., Yongin-si (KR)

(72) Inventors: Dong Gyu Yeo, Yongin-si (KR); Je Hyun Lee, Yongin-si (KR)

(73) Assignee: Samsung SDI Co., Ltd., Yongin-si (KR)

(21) Appl. No.: 18/907,130

(22) Filed: Oct. 4, 2024

(30) Foreign Application Priority Data
Apr. 9, 2024 (KR) 10-2024-0047822

(51) Int. Cl. H01M 10/04; H01M 10/44

(52) U.S. Cl. CPC H01M 10/0468; H01M 10/0431; H01M 10/446

(57) ABSTRACT

Disclosed are a press plate capable of effectively flattening a pouch-type cell and also a method of manufacturing a pouch-type cell using the same. The press plate for flattening a pouch-type cell includes a surface facing the pouch-type cell, and the surface facing the pouch-type cell includes at least a portion made of an elastic material.

### CROSS-REFERENCE TO RELATED APPLICATIONS

This present application claims priority to and the benefit under 35 U.S.C. § 119(a)-(d) of Korean Patent Application No. 10-2024-0047822, filed on Apr. 9, 2024, in the Korean Intellectual Property Office, the entire disclosure of which is incorporated herein by reference.

### FIELD

The present disclosure relates to a press plate for flattening a pouch-type cell and a method of manufacturing a pouch-type cell using the same.

### BACKGROUND

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

The present disclosure provides, in some embodiments, a press plate capable of effectively flattening a pouch-type cell and a method of manufacturing a pouch-type cell using the same.

These and other aspects and features of the present disclosure will be described in or will be apparent from the following description of embodiments of the present disclosure.

In order to accomplish at least the above objective, a press plate for flattening a pouch-type cell according to some embodiments of the present disclosure includes a surface facing the pouch-type cell, wherein the surface facing the pouch-type cell includes at least a portion made of an elastic material.

In some examples, the portion of the surface facing the pouch-type cell may be made of a urethane-based material.

In some examples, the portion of the surface facing the pouch-type cell may be formed to have a hardness (e.g., Shore A) rating of 40 to 60.

In some examples, the surface facing the pouch-type cell may be entirely made of an elastic material.

In some examples, the pouch-type cell may include an electrode assembly, a case accommodating the electrode assembly, and a lead tab protruding out from the electrode assembly to an area outside of the case. The surface facing the pouch-type cell may include a first area corresponding to a portion of the case opposite a portion of the case from which the lead tab is protruding out, and the first area may be made of an elastic material.

In some examples, the surface facing the pouch-type cell may include a second area corresponding to the portion of the case from which the lead tab is protruding out, and the second area may be made of a rigid material.

In some examples, the second area may be made of steel.

In some examples, the press plate may be configured to press the pouch-type cell at a pressure in a range of 4 kgf/mm² to 8 kgf/mm².

A method of manufacturing a pouch-type cell according to some embodiments of the present disclosure includes preparing a pouch-type cell, performing a charging/discharging cycle on the pouch-type cell, and pressing the pouch-type cell using a press plate to flatten the pouch-type cell, wherein the press plate includes a surface facing the pouch-type cell, and the surface facing the pouch-type cell includes at least a portion made of an elastic material.

In some examples, the portion of the surface of the press plate facing the pouch-type cell may be made of a urethane-based material.

In some examples, the portion of the surface of the press plate facing the pouch-type cell may be formed to have a hardness (e.g., Shore A) rating of 40 to 60.

In some examples, the surface of the press plate facing the pouch-type cell may be entirely made of an elastic material.

In some examples, the pouch-type cell may include an electrode assembly, a case accommodating the electrode assembly, and a lead tab protruding out from the electrode assembly to an area outside of the case. The surface of the press plate facing the pouch-type cell may include a first area corresponding to a portion of the case opposite a portion of the case from which the lead tab is protruding out, and the first area may be made of an elastic material.

In some examples, the surface of the press plate facing the pouch-type cell may include a second area corresponding to the portion of the case from which the lead tab is protruding out, and the second area may be made of a rigid material.

In some examples, the second area may be made of steel.

In some examples, the press plate may press the pouch-type cell at a pressure in a range of 4 kgf/mm² to 8 kgf/mm².

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a schematic view showing a process of flattening a pouch-type cell using a press plate for flattening a pouch-type cell, according to some embodiments of the present disclosure;

FIG. 2 is an exploded perspective view showing an exemplary pouch-type cell to which the press plate for flattening a pouch-type cell, according to some embodiments of the present disclosure, is applicable;

FIG. 3 is a graph indicating a result of flattening a pouch-type cell using the press plate for flattening a pouch-type cell according to the exemplary embodiment depicted in FIG. 1 of the present disclosure and a result of flattening a pouch-type cell using a press plate manufactured for comparison;

FIG. 4 is a schematic view showing a process of flattening a pouch-type cell using a press plate for flattening a pouch-type cell, according to other embodiments of the present disclosure; and

FIG. 5 is a flowchart showing a method of manufacturing a pouch-type cell using a press plate for flattening a pouch-type cell, according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

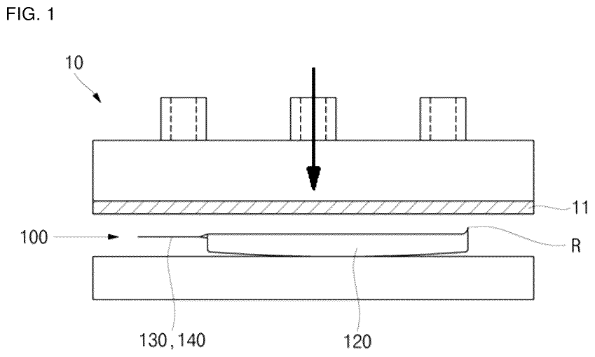

FIG. 1 is a schematic view showing a process of flattening a pouch-type cell 100 using a press plate 10 for flattening a pouch-type cell, according to some embodiments of the present disclosure.

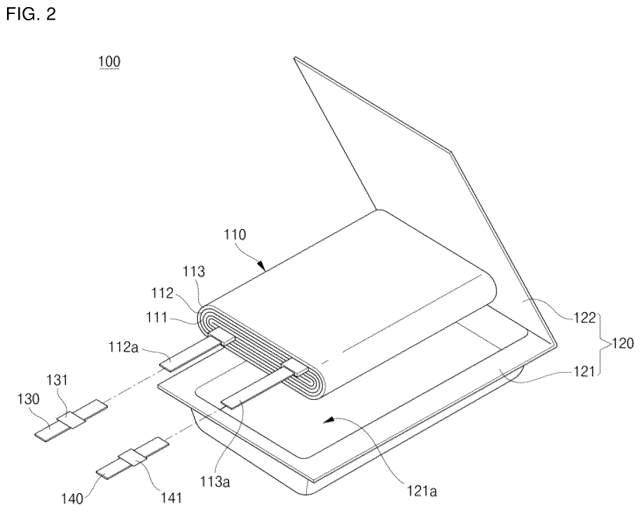

As shown in FIG. 2, the pouch-type cell 100 according to some embodiments of the present disclosure may include an electrode assembly 110, a case 120, a first lead tab 130, and a second lead tab 140.

The electrode assembly 110 may be formed by winding or stacking a stack of a first electrode plate 112, a separator 111, and a second electrode plate 113. The first and second electrode plates 112 and 113 and the separator 111 may be formed in the shape of a thin plate or a thin film. If the electrode assembly 110 is formed by winding the stack, the winding axis thereof may be parallel to the longitudinal direction of the case 120. In other embodiments, the electrode assembly 110 may be of a stacked type rather than a wound type. The disclosure is not limited to any specific shape of the electrode assembly 110. In other embodiments, the electrode assembly 110 may be a Z stack electrode assembly in which the separator is bent in a Z-shape and a positive electrode plate and a negative electrode plate are respectively inserted into both sides of the separator. In some embodiments, one or more electrode assemblies 110 may be accommodated in the case 120 in a state of being stacked such that long side surfaces thereof are adjacent to each other. The disclosure is not limited as to the number of electrode assemblies 110. The first electrode plate 112 of the electrode assembly 110 may serve as a negative electrode, and the second electrode plate 113 of the electrode assembly 110 may serve as a positive electrode. In other embodiments, the reverse may also be possible in which the first electrode plate 112 of the electrode assembly 110 serves as a positive electrode, and the second electrode plate 113 of the electrode assembly 110 serves as a negative electrode.

The first electrode plate 112 may be formed by coating a first electrode active material, such as graphite or carbon, on a first electrode current collector, which may be formed as a metal foil made of copper, a copper alloy, nickel, or a nickel alloy, and may include a first electrode tab (or first uncoated portion) 112a, which is an area not coated with the first electrode active material. The first electrode tab 112a may serve as a passage for flow of current between the first electrode plate 112 and the first lead tab 130. In some examples, the first electrode tab 112a may be formed in advance through cutting so as to protrude in one direction when manufacturing the first electrode plate 112 or may be formed so as to protrude farther in one direction than the separator 111 without a separate cutting process.

The second electrode plate 113 may be formed by coating a second electrode active material, such as a transition metal oxide, on a second electrode current collector, which may be formed as a metal foil made of aluminum or an aluminum alloy, and may include a second electrode tab (or second uncoated portion) 113a, which is an area not coated with the second electrode active material. The second electrode tab 113a may serve as a passage for flow of current between the second electrode plate 113 and the second lead tab 140. In some examples, the second electrode tab 113a may be formed in advance through cutting so as to protrude in one direction when manufacturing the second electrode plate 113 or may be formed so as to protrude farther in one direction than the separator 111 without a separate cutting process.

In some examples, the first electrode tab 112a may be located on the left side of the electrode assembly 110, and the second electrode tab 113a may be located on the right side of the electrode assembly 110. In other embodiments, the first electrode tab 112a and the second electrode tab 113a may be respectively located on surfaces of the electrode assembly 110 that face in opposite directions. For example, the left side and the right side may be defined on the basis of the cell shown in FIG. 2 for simplicity of description, and the positions thereof may be changed if the cell is rotated left and right or up and down.

The first electrode tab 112a of the first electrode plate 112 and the second electrode tab 113a of the second electrode plate 113 may be located on one end portion of the electrode assembly 110. In some examples, the electrode assembly 110 may be accommodated in the case 120 together with an electrolyte. In some examples, the first lead tab 130 and the second lead tab 140 may be respectively welded and connected to the first electrode tab 112a of the first electrode plate 112 and the second electrode tab 113a of the second electrode plate 113 exposed from one side of the electrode assembly 110.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The case 120 may be formed in a so-called pouch shape to accommodate the electrode assembly 110.

In more detail, the case 120 may include a first pouch member 121 including a concave internal space 121a defined therein to accommodate the electrode assembly 110 and a second pouch member 122 formed to be substantially flat to cover the first pouch member 121.

The concave internal space 121a may be defined in the first pouch member 121 in a manner of, for example, preparing a substantially flat sheet and then performing a forming process using a punch on the central portion of the flat sheet in a state of tightly holding the edge of the flat sheet.

The first pouch member 121 and the second pouch member 122 may be manufactured separately from each other or may be manufactured integrally with each other so as to be foldable at a boundary therebetween. The latter case is illustrated in FIG. 2.

In some examples, the first pouch member 121 and the second pouch member 122 may be bonded to each other along the edges thereof.

The first lead tab 130 may be led/protruding out from the first electrode plate 112 of the electrode assembly 110 to an area outside of the case 120 through a region between the first pouch member 121 and the second pouch member 122. An insulating member 131 may be provided on a portion of the first lead tab 130 contacting the case 120 in order to prevent short circuit to the case 120.

The second lead tab 140 may be led/protruding out from the second electrode plate 113 of the electrode assembly 110 to the outside of the case 120 through a region between the first pouch member 121 and the second pouch member 122. An insulating member 141 may be provided on a portion of the second lead tab 140 contacting the case 120 in order to prevent short circuit to the case 120.

Due to the forming of the structure of the pouch-type cell 100, an empty space may be present at a lower portion of the pouch-type cell 100, e.g., a portion opposite the portion through which the first and second lead tabs 130 and 140 are led/protruding out. Thus, when a charging/discharging cycle is performed on the pouch-type cell 100, a negative pressure may be formed inside the case 120, and a lower portion of the case 120 may be pulled into the empty space at the lower portion of the pouch-type cell 100, and accordingly (i.e., as a result of the deformation of the lower portion of the case 120), a portion R of the edge of the case 120 corresponding thereto may rise (hereinafter referred to as a raised portion R). It is to be understood that the size and shape of the raised portion R are exaggerated in FIG. 1 for simplicity and clarity of description. The raised portion R may be opposite a portion of the case from which the lead tab is protruding out. The height of the raised portion R may be included in the overall thickness of the pouch-type cell 100. This may mean that the overall thickness of the pouch-type cell 100 increases due to the raised portion R and thus a thickness defect occurs.

In order to solve the above problem, a press plate 10 for flattening a pouch-type cell according to some embodiments of the present disclosure (hereinafter briefly referred to as a “press plate” for simplicity of description) may serve/be used to press the raised portion R to flatten the pouch-type cell 100.

The press plate 10 may include a surface 11 facing the surface of the pouch-type cell 100 on which the raised portion R is created. The surface 11 of the press plate 10 facing the surface of the pouch-type cell 100 on which the raised portion R is created may be made of an elastic material and may be formed to be soft. The surface facing the pouch-type cell may be made entirely of an elastic material. In more detail, the surface 11 of the press plate 10 may be made of a urethane-based material.

In one example, the urethane-based material may be heat-resistant urethane or Vulkollan.

Thus, in a state of being in contact with the surface of the pouch-type cell 100 on which the raised portion R is created, the press plate 10 may press the pouch-type cell 100 so as to modify the outer appearance of the pouch-type cell 100 without damaging the interior of the pouch-type cell 100.

Taking into consideration that the pouch-type cell is typically designed to have a thickness of about 3.5 mm to about 4.5 mm, the press plate 10 may be formed such that the surface 11 has a hardness (e.g., Shore A)/hardness rating of about 40 to about 60 and may be formed to press the pouch-type cell 100 at a pressure of about 4 kilogram-force/millimeter² (kgf/mm²) to about 8 kgf/mm².

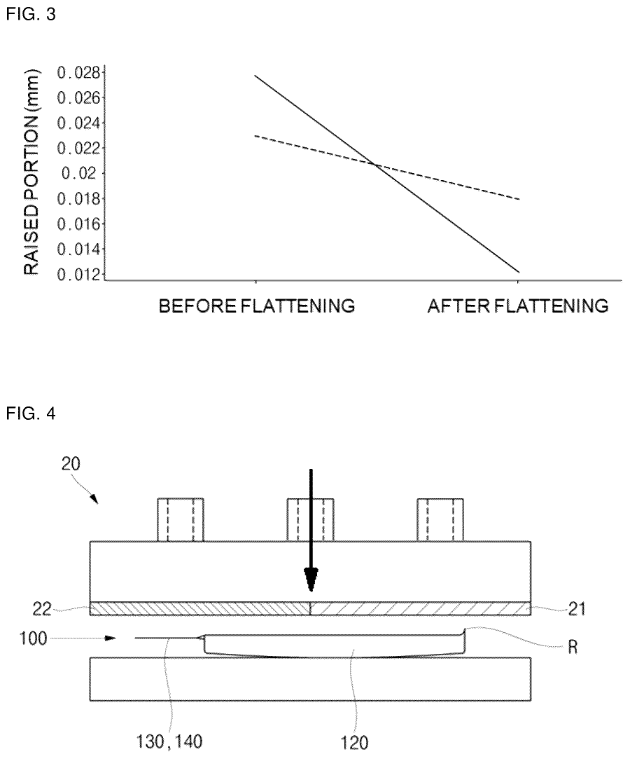

FIG. 3 is a graph indicating a result of flattening the pouch-type cell 100 using the press plate 10 according to the depicted embodiment of FIG. 1 and a result of flattening the pouch-type cell 100 using a press plate manufactured for comparison (hereinafter referred to as a “comparative press plate”). In FIG. 3, the result of flattening the pouch-type cell 100 using the press plate 10 according to the depicted embodiment of the present disclosure in FIG. 1 is indicated by a solid line, and the result of flattening the pouch-type cell 100 using the comparative press plate is indicated by a dashed line.

In the press plate 10 according to the exemplary embodiment of the present disclosure used in this experiment, the surface 11 thereof facing the surface of the pouch-type cell 100 on which the raised portion R is created is made of a urethane-based material (Vulkollan) having hardness (e.g., Shore A) of about 50, as mentioned above. In the comparative press plate used in this experiment, the surface thereof facing the surface of the pouch-type cell 100 on which the raised portion R is created is made of steel, unlike the press plate 10 according to the embodiment of the present disclosure used in the experiment.

Referring to FIG. 3, it may be seen that, if the pouch-type cell 100 having a raised portion R having a height of about 22 micrometer (μm) is pressed at a pressure of about 4 kgf/mm² by the comparative press plate, the height of the raised portion R is reduced by about 4 μm, i.e., to about 18 μm.

In order to demonstrate that the press plate 10 according to the embodiment of the present disclosure depicted in FIG. 1 is capable of more effectively reducing the height of the raised portion R, the present Applicant deliberately increased the initial height of the raised portion R. It may be seen from FIG. 3 that, if the pouch-type cell 100 having a raised portion R having a height of about 28 μm is pressed at a pressure of about 4 kgf/mm² by the press plate 10 according to the exemplary embodiment of the present disclosure depicted in FIG. 1, the height of the raised portion R is reduced by about 16 μm, i.e., to about 12 μm.

In conclusion, it may be confirmed that, even though the initial height of the raised portion R is greater than that in the comparative example, the press plate 10 according to the exemplary embodiment of the present disclosure is capable of significantly and reliably reducing the height of the raised portion R compared to the comparative press plate.

FIG. 4 is a schematic view showing a process of flattening the pouch-type cell 100 using a press plate 20 for flattening a pouch-type cell, according to other embodiments of the present disclosure.

Referring to FIG. 4, compared to the press plate 10 according to the above-described embodiments of the present disclosure in which the entirety of the surface 11 thereof facing the surface of the pouch-type cell 100 on which the raised portion R is created is made of an elastic material, e.g., a urethane-based material, the press plate 20 according to other embodiments of the present disclosure may be characterized in that a surface thereof facing the surface of the pouch-type cell 100 on which the raised portion R is created is divided into an area 21 corresponding to the raised portion R and an area 22 corresponding to the first and second lead tabs 130 and 140. In some embodiments, the area 21 is made of an elastic material, and the area 22 is made of a rigid material.

In more detail, in the press plate 20 according to the other embodiments of the present disclosure, the surface thereof facing the surface of the pouch-type cell 100 on which the raised portion R is created may include at least two areas 21 and 22.

The area 21 may be a portion of the surface including an area 21 corresponding to the raised portion R, e.g., an area 21 in direct contact with the raised portion R (hereinafter referred to as a “first area” for simplicity of description). The first area 21 may be made of an elastic material. In more detail, the first area 21 may be made of a urethane-based material, e.g., Vulkollan. The first area 21 may be formed to have a hardness (e.g., Shore A)/hardness rating of 40 to 60 taking into consideration general pouch-type cells.

The other area 22 may be an area 22 corresponding to the portion of the case from which the first and second lead tabs 130 and 140 protrude out, e.g., an area 22 that approaches the upper sides of the first and second lead tabs 130 and 140 (hereinafter referred to as a “second area” for simplicity of description) when the press plate 20 presses the pouch-type cell 100. The second area 22 may be made of a rigid material. For example, the second area 22 may be made of steel.

The press plate 20 according to the other embodiments of the present disclosure may serve to flatten the pouch-type cell 100 by pressing the raised portion R.

Because the first area 21 corresponding to the raised portion R is made of an elastic material, in some embodiments, e.g., a urethane-based material, the press plate 20 may press the pouch-type cell 100 so as to modify the outer appearance of the pouch-type cell 100 without damaging the interior of the pouch-type cell 100 in a state of being in contact with the surface of the pouch-type cell 100 on which the raised portion R is created.

Because the second area 22 corresponding to the first and second lead tabs 130 and 140 is made of a rigid material, in some embodiments, e.g., steel, it may be possible to prevent the first and second lead tabs 130 and 140 from being unintentionally and undesirably deformed during a process of further pressing the pouch-type cell 100 in order to press the raised portion R more strongly.

Similarly to the press plate 10 according to the above-described embodiments of the present disclosure, the press plate 20 according to the other embodiments of the present disclosure may also be formed to press the pouch-type cell 100 at a pressure in a range of 4 kgf/mm² to 8 kgf/mm².

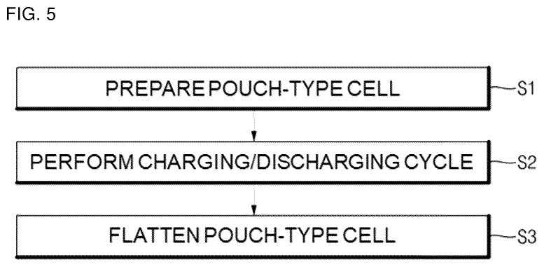

FIG. 5 is a flowchart showing a method of manufacturing a pouch-type cell using a press plate for flattening a pouch-type cell, according to some embodiments of the present disclosure.

The press plate for flattening a pouch-type cell may be the press plate 10 according to some embodiments of the present disclosure or the press plate 20 according to other embodiments of the present disclosure.

First, the pouch-type cell described above with reference to FIG. 2 may be prepared (at act S1).

Thereafter, a charging/discharging cycle may be performed on the pouch-type cell (at act S2). The process of performing the charging/discharging cycle is typically called an activation process or a formation process. This process itself may be substantially the same as that known in the art or could be easily derived therefrom by a person skilled in the art, and thus a detailed description thereof will be omitted.

As mentioned above, when the charging/discharging cycle is performed on the pouch-type cell, a negative pressure may be formed inside the case, and a lower portion of the case may be pulled into an empty space present at a lower portion of the pouch-type cell, and accordingly (i.e., as a result of the deformation of the lower portion of the case), a raised portion may be created on the edge of the case corresponding thereto.

Subsequently, the pouch-type cell may be flattened by pressing the raised portion using the press plate according to the embodiments of the present disclosure (at act S3).

In the press plate according to some embodiments of the present disclosure, the portion thereof pressing the raised portion of the pouch-type cell may be made of an elastic material, e.g., a urethane-based material, and may be formed to be soft. Thus, the press plate according to some embodiments of the present disclosure may press the pouch-type cell so as to modify the outer appearance of the pouch-type cell without damaging the interior of the pouch-type cell in a state of being in contact with the surface of the pouch-type cell on which the raised portion is created, thereby effectively reducing the height of the raised portion.

In other embodiments, the manufacturing method may further include a step of removing gas from the pouch-type cell, i.e., a degassing process, between the step of preparing the pouch-type cell (act S1) and the step of performing the charging/discharging cycle on the pouch-type cell (act S2) or between the step of performing the charging/discharging cycle on the pouch-type cell (act S2) and the step of flattening the pouch-type cell using the press plate according to the embodiments of the present disclosure (act S3).

The step of flattening the pouch-type cell using the press plate according to the embodiments of the present disclosure (act S3) may correspond to a separate step different from the degassing process. Thus, the press plate according to the embodiments of the present disclosure may correspond to a separate device different from a device used in the degassing process.

As is apparent from the above description, according to some embodiments of the present disclosure, because a portion of a press plate that presses a raised portion of a pouch-type cell is made of an elastic material, the press plate may press the pouch-type cell without damaging the interior of the pouch-type cell, thereby effectively reducing the height of the raised portion.

According to other embodiments of the present disclosure, in the press plate, an area corresponding to the raised portion may be made of an elastic material, and an area corresponding to tabs may be made of a rigid material, e.g., steel. Thus, it may be possible to prevent the tabs from being unintentionally and undesirably deformed during a process of further pressing the pouch-type cell in order to press the raised portion more strongly.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A press plate for flattening a pouch-type cell, the press plate comprising:
a surface facing the pouch-type cell,
wherein the surface facing the pouch-type cell comprises at least a portion made of an elastic material.

2. The press plate as claimed in claim 1, wherein the portion of the surface facing the pouch-type cell is made of a urethane-based material.

3. The press plate as claimed in claim 1, wherein the portion of the surface facing the pouch-type cell is formed to have a hardness Shore A rating of 40 to 60.

4. The press plate as claimed in claim 1, wherein the surface facing the pouch-type cell is entirely made of an elastic material.

5. The press plate as claimed in claim 1, wherein the pouch-type cell comprises:
an electrode assembly;
a case accommodating the electrode assembly; and
a lead tab protruding out from the electrode assembly to an area outside of the case,
wherein the surface facing the pouch-type cell comprises a first area corresponding to a portion of the case opposite a portion of the case from which the lead tab is protruding out, and
wherein the first area is made of an elastic material.

6. The press plate as claimed in claim 5, wherein the surface facing the pouch-type cell comprises a second area corresponding to the portion of the case from which the lead tab is protruding out, and
wherein the second area is made of a rigid material.

7. The press plate as claimed in claim 6, wherein the second area is made of steel.

8. The press plate as claimed in claim 1, wherein the press plate is configured to press the pouch-type cell at a pressure in a range of 4 kgf/mm² to 8 kgf/mm².

9. A method of manufacturing a pouch-type cell, the method comprising:
preparing the pouch-type cell;
performing a charging/discharging cycle on the pouch-type cell; and
pressing the pouch-type cell using a press plate to flatten the pouch-type cell,
wherein the press plate comprises a surface facing the pouch-type cell, and
wherein the surface facing the pouch-type cell comprises at least a portion made of an elastic material.

10. The method as claimed in claim 9, wherein the portion of the surface of the press plate facing the pouch-type cell is made of a urethane-based material.

11. The method as claimed in claim 9, wherein the portion of the surface of the press plate facing the pouch-type cell is formed to have a hardness Shore A rating of 40 to 60.

12. The method as claimed in claim 9, wherein the surface of the press plate facing the pouch-type cell is entirely made of an elastic material.

13. The method as claimed in claim 9, wherein the pouch-type cell comprises:
an electrode assembly;
a case accommodating the electrode assembly; and
a lead tab protruding out from the electrode assembly to an area outside of the case,
wherein the surface of the press plate facing the pouch-type cell comprises a first area corresponding to a portion of the case opposite a portion of the case from which the lead tab is protruding out, and
wherein the first area is made of an elastic material.

14. The method as claimed in claim 13, wherein the surface of the press plate facing the pouch-type cell comprises a second area corresponding to the portion of the case from which the lead tab is protruding out, and
wherein the second area is made of a rigid material.

15. The method as claimed in claim 14, wherein the second area is made of steel.

16. The method as claimed in claim 9, wherein the press plate presses the pouch-type cell at a pressure in a range of 4 kgf/mm² to 8 kgf/mm².
